(19) United States
(12) Patent Application Publication
(10) Pub. No.: US 2026/0185364 A1
(43) Pub. Date: Jul. 2, 2026

(54) DECORATIVE SHEET OR DECORATIVE PANEL

(71) Applicant: UNILIN, BV, Wielsbeke (BE)

(72) Inventors: Benjamin CLEMENT, Wielsbeke (BE); Sam LEDEGEN, Wielsbeke (BE); Marijn SEYNAEVE, Wielsbeke (BE)

(21) Appl. No.: 19/127,540

(22) PCT Filed: Nov. 9, 2023
(86) PCT No.: PCT/IB2023/061324

§ 371 Date: May 6, 2025

Related U.S. Application Data
(60) Provisional application No. 63/425,035, filed on Nov. 14, 2022.
(60) Provisional application No. 63/483,079, filed on Feb. 3, 2023.

(30) Foreign Application Priority Data
Mar. 23, 2023 (EP) 23163623.4
Jun. 23, 2023 (EP) 23181208.2

(51) Int. Cl. E04F 15/10; B32B 3/06; B32B 21/02; B32B 21/06; B32B 21/08; B32B 25/02; B32B 27/20; E04F 15/02

(52) U.S. Cl. CPC E04F 15/107; B32B 3/06; B32B 21/02; B32B 21/06; B32B 21/08; B32B 25/02; B32B 27/20; E04F 15/02038; B32B 2250/05; B32B 2255/12; B32B 2260/028; B32B 2260/046; B32B 2307/51; B32B 2307/7376; B32B 2471/00; E04F 2201/0153; E04F 2201/042; E04F 2201/043

(57) ABSTRACT

A decorative sheet or decorative panel less than 5 mm thick including a substrate, a decor layer and optionally one or more of a wear layer, a balancing layer and a resilient pad attach bottom layer. The substrate has a core layer; and an upper layer and/or a lower layer. The core layer includes core layer particles and a thermoplastic or elastomeric halogen-free binder. The core layer particles are selected from wood particles, cellulosic particles and cork particles, or a combination thereof.

The invention relates to decorative sheets and decorative panels that can be used as floor covering or for composed elements such as furniture. The invention also relates to a method to manufacture such decorative sheets and decorative panels.

Thin decorative sheets and thin decorative panels are known that comprise a decor layer laminated onto a substrate out of polyvinyl chloride with mineral filers. Such products can be glued onto the underground to form a floor covering, or can be loose laid.

WO2021/175981A1 discloses such a sheet flooring for loose-lay installation on a subfloor. The sheet flooring is provided in the form of a roll and comprises a core layer assembly including one or more core layers.

Due to environmental concerns, there is increasing interest to reduce the use of polyvinyl chloride, including for floor coverings.

The object of the invention is to provide non-polyvinyl chloride containing thin decorative sheets and thin decorative panels.

The object of the invention is also to provide a method to manufacture such non-polyvinyl chloride containing thin decorative sheets and thin decorative panels in an efficient way.

The first aspect of the invention is a decorative sheet or decorative panel, wherein the decorative sheet or the decorative panel is less than 5 mm thick, preferably less than 4.5 mm thick, more preferably less than 3.5 mm thick, and more preferably less than 3 mm thick. The decorative sheet or decorative panel is characterized in that it comprises or consists of a substrate, a decor layer and optionally one or more of a wear layer, a balancing layer and a resilient pad attach bottom layer. The substrate consists of a core layer; and optionally an upper layer and/or a lower layer. The core layer comprises core layer particles and a thermoplastic or elastomeric halogen-free binder. The core layer particles are selected from wood particles—preferably wood chips and/or wood fibers—, cellulosic particles and cork particles, or a combination thereof.

Decorative sheets or decorative panels according to the invention can be used as floor panels, as wall panels, as ceiling panels or as furniture panels.

Decorative sheets or decorative panels according to the invention provides a durable alternative for polyvinyl chloride based sheets or panels of similar thickness.

Thin decorative panels have the benefit that less material is required for producing them. The use of less material is favorable giving the environmental stress of all use of materials.

The composition of the core layer provides prevents to a large extent noise generation when walking on a floor covering comprising such decorative sheet or decorative panels.

An optional resilient pad attach bottom layer can be provided for further improved sound dampening purposes when using the decorative sheet or decorative panel in a flooring.

In embodiments wherein the substrate consists of a core layer, an upper layer and a lower layer, the core layer is provided between the upper layer and the lower layer. Preferably the core layer is thicker than each of the upper layer and the lower layer. More preferably, the upper layer and the lower layer have the same thickness.

When an upper layer is present, it is provided between the core layer and the décor layer. When a lower layer is present, it is provided at the other side of the core layer than the side where the décor layer is present.

Embodiments in which the substrate comprises an upper layer and/or a lower layer besides a core layer are beneficial, as the properties of the sheet of panel can be better tailored.

Embodiments wherein the decorative sheet or decorative panel comprises a balancing layer are beneficial especially when the décor layer is laminated into the decorative sheet or decorative panel and when the balancing layer is laminated using the same adhesive technology as with which the décor layer is laminated into the decorative sheet or decorative panel. This is beneficial as the balancing layer can result in the sheet or panel staying flat when in use, e.g. as floor panel. Thus, preventing deformations such as cupping.

The decorative sheet or decorative panel can be halogen free, which allows it to be burnt at the end of life, which allows to recuperate energy.

A preferred decorative sheet or decorative panel is characterized in that the thermoplastic or elastomeric halogen-free binder is selected from the list of polyvinyl butyral (PVB), styrene butadiene copolymer, ethylene vinyl acetate (EVA), polylactic acid (PLA), vinyl acetate-ethylene-vinyl ester copolymers, biobased polyester—e.g. polyhydroxyalkanoates—, thermoplastic polyurethanes, starch, polyolefines or mixtures thereof.

Such binders are preferred because they do not contain harmful plasticizers. It is a further benefit that these binders do not contain halogens. The use of biobased polyester has the benefit that it is biodegradable and that a larger percentage of material used is bio-based besides the core layer particles which are bio-based.

It is a benefit of the use of polyvinyl butyral (PVB) that PVB can be obtained from end-of-life wind shields of cars, resulting in re-use of the PVB, contributing in more eco-friendly production.

It is a benefit of the use of styrene butadiene copolymer that the core layer can be produced via extrusion.

It is a benefit of the use of styrene butadiene copolymer that it has a low processing temperature, making it well suited for combination with the core layer particles.

A preferred decorative sheet or decorative panel is characterized in that the core layer comprises an additional binder. The additional binder is selected from the list of thermoset binder, polyurethane, hyperbranched polyamide, thermoset polyester or mixtures thereof.

Such embodiments are preferred, as a more rigid product is obtained.

The use of polyurethane as additional binder is particularly preferred, as it results in a, even more rigid decorative sheet or decorative panel.

More preferably, the relative amount of the additional binder in the combination of the halogen-free binder and the additional binder is between 1 and 15 mass percent.

The weight percentage of the thermoplastic or elastomeric halogen-free binder in the core layer can preferably be at least 30%; and preferably more than 45%. It is a benefit of such embodiments that the sheet or panel has an improvement resistance to water, improving its durability.

A preferred embodiment is characterized in that the core layer comprises reinforcement fibers, more preferably selected from glass fibers, polyvinyl alcohol fibers or basalt fibers. Reinforcement fibers have the benefit that the mechanical properties of the decorative sheet or decorative panel are improved.

More preferably, the core layer comprises between 0.5 and 8 percent by mass of reinforcement fibers.

A preferred embodiment is characterized in that the core layer comprises fillers. More preferably, the fillers are selected from perlite, expanded glass particles, calcium carbonate, or talc; or a combination thereof.

Fillers can be present to decrease the cost of the sheet or panel, and/or to tailor its properties; e.g. the weight of the sheet or panel.

The core layer can comprise a plasticizer, preferably a biobased plasticizer or a protein based plasticizer, e.g. gluten.

The incorporation of plasticizers has the benefit that the flexibility of the bonding of the core layer, and of the decorative sheet or decorative panel is improved, for optimized functionality of the product.

The plasticizer can be selected from ortho phthalates such as DINP (diisononyl phthalate, DPHP), di(2-propylheptyl) phthalate; terephthalates such as DOTP (dioctyl terephthalate or DBT (dibutyl terephthalates); (cyclo) hexanoates such as DINCH, 1,2-cyclohexane dicarboxylic acid diisononyl ester; adipates such as DOA (dioctyl adipate); benzoates such as IDB (isodecyl benzoate), and vegetable oil based plasticizers such as ESBO.

Biobased plasticizers or a protein based plasticizer, e.g. gluten, are particularly preferred as they are not harmful, and as they are biobased.

A preferred decorative sheet or decorative panel is characterized in that the substrate comprises an upper layer between the core layer and the decor layer. The upper layer comprises upper layer particles and an upper layer binder. The upper layer particles are selected from wood particles—preferably wood chips and/or wood fibers—, cellulosic particles, and cork particles, or combinations thereof. The upper layer binder is a thermoplastic or elastomeric halogen-free binder.

The provision of an upper layer allows to tailor and optimize the properties—e.g. the mechanical properties—of the decorative sheet or decorative panel.

The optional provision of an upper layer also allows to select the composition and the properties of the core layer more freely.

Preferably, the mass percentage of the upper layer binder in the upper layer is lower than the mass percentage of the thermoplastic or elastomeric halogen-free binder of the core layer.

The upper layer can be scattered first in a scattering operation in the manufacturing process for manufacturing the sheet or panel. The layer scattered first contacts the surface—e.g. a conveyer belt—onto which the scattering is performed. Providing an upper layer scattered first and comprising a lower mass percentage of binder compared to the core layer prevents adhesion of the sheet or panel being formed onto the surface onto which the scattering is performed. The particles for the core layer can then be scattered onto the particles forming the upper layer without risk of stickiness of adhesion to the surface onto which the scattering is performed.

The upper layer can comprise a thermoset upper layer binder. It means that the amount of the upper layer binder—which is a thermoplastic or elastomeric halogen-free binder—can be further reduced; which prevents stickiness during production of the panel or sheet even more.

The optional thermoset upper layer binder can be selected from the list of thermoset binder, polyurethane, hyperbranched polyamide, thermoset polyester or mixtures thereof.

The upper layer binder can have the same chemical composition as the thermoplastic or elastomeric halogen-free binder of the core layer. It is a benefit of such embodiments that the sheet of panel is more uniform in components, facilitating its recycling.

The upper layer preferably contacts the core layer.

The decor layer can be laminated or otherwise provided onto the upper layer.

A preferred decorative sheet or decorative panel is characterized in that the substrate comprises a lower layer at the other side of the core layer than the decor layer. The lower layer comprises lower layer particles and a lower layer binder. The lower layer particles are selected from wood particles—preferably wood chips and/or wood fibers—, cellulosic particles and cork particles or combinations thereof. The lower layer binder is a thermoplastic or elastomeric halogen-free binder.

The lower layer can be scattered first in a scattering operation in the manufacturing process for manufacturing the sheet or panel. The layer scattered first contacts the surface—e.g. a conveyer belt—onto which the scattering is performed. Providing lower layer scattered first and comprising a lower mass percentage of binder compared to the core layer prevents adhesion of the sheet or panel being formed onto the surface onto which the scattering is performed. The particles for the core layer can then be scattered onto the particles forming the lower layer without risk of stickiness of adhesion to the surface onto which the scattering is performed.

The lower layer can comprise a thermoset lower layer binder. It means that the amount of the lower layer binder—which is a thermoplastic or elastomeric halogen-free binder—can be further reduced; which prevents stickiness during production of the panel or sheet even more.

The optional thermoset lower layer binder can be selected from the list of thermoset binder, polyurethane, hyperbranched polyamide, thermoset polyester or mixtures thereof.

The lower layer binder can have the same chemical composition as the thermoplastic or elastomeric halogen-free binder of the core layer. It is a benefit of such embodiments that the sheet of panel is more uniform in components, facilitating its recycling.

The optional lower layer preferably contacts the core layer.

The optional lower layer preferably provides the bottom of the decorative sheet or decorative panel. However alternatively, a balancing layer or a resilient pad attach bottom layer can be provided onto the optional lower layer.

The upper layer and the lower layer can have the same thickness.

Embodiments comprising an upper layer and a lower layer are particularly preferred, as they provide a balanced composition of the decorative sheet or decorative panel, even more when the upper layer and the lower layer have the same thickness and/or the same composition.

Preferably, the core layer is thicker than the lower layer and than the upper layer.

The decor layer can comprise a digitally printed decor, preferably wherein the digitally printed decor is printed onto the substrate or onto the optional upper layer. Printing the décor onto the substrate or onto the optional upper layer is beneficial, as no separate carrier sheet for the printed décor is required, reducing the use of materials in the decorative sheet or decorative panel.

The decor layer can comprise a decor printed onto a carrier sheet. The carrier sheet can comprise a paper sheet or a polymer foil.

A preferred embodiment is characterized in that the décor layer comprises a resin impregnated printed paper sheet. The print on the printed paper sheet can provide the décor of the décor layer. Such resin impregnated printed paper sheets can be laminated onto the substrate, e.g. by means of the resin of the resin impregnated printed paper sheet, or by an additional adhesive layer, e.g. by means of a polyurethane adhesive.

The resin of the resin impregnated printed paper sheet can preferably be an acrylate resin or a melamine formaldehyde resin.

A preferred embodiment is characterized in that the carrier sheet with its printed decor is laminated onto the substrate; or onto the optional upper layer, preferably by means of an adhesive; e.g. a polyurethane adhesive, a PUR (reactive polyurethane) hotmelt or a polyvinyl acetate adhesive. Such embodiments provide a durable bonding of the décor layer into the decorative sheet or decorative panel, given the specific composition of its substrate.

A preferred decorative sheet of decorative panel is characterized in that the decor layer is provided by a High Pressure Laminate (HPL) or by a Continuous Pressure Laminate (CPL) laminated onto the substrate or onto the optional upper layer. Such embodiments provide a durable bonding of the décor layer into the decorative sheet or decorative panel, given the specific composition of its substrate.

A preferred decorative sheet or decorative panel comprises a balancing layer, wherein the balancing layer is laminated in the same way into the sheet or panel as the décor layer. Such embodiments are preferred, as deformation—e.g. cupping—during use of the decorative sheet or decorative panel are prevented, as the product has a more symmetrical, and thus more balanced construction.

The decorative sheet or decorative panel preferably comprises a wear layer; wherein the wear layer comprises a lacquer layer, or a thermoplastic film—optionally comprising a lacquer layer—, or a resin impregnated paper layer. The wear layer provides improved durability to the decorative sheet or decorative panel, of particular importance for use as floor covering.

Lacquer layers that can be used in the inventions are e.g. acrylic lacquer layers, more preferably UV-cured acrylic lacquer layers.

The decorative sheet or decorative panel can comprise a textured surface, more preferably wherein the textured surface is obtained by a pressing or embossing operation. The texture can be in register with a printed décor. Such embodiments provide decorative sheets or decorative panels having a realistic imitation of a natural product, such as e.g. a wood panel or a marble panel.

In a particularly preferred embodiment a decorative sheet according to the first aspect of the invention is provided as a roll. Such decorative sheet can be stored efficiently, and unrolled for installation as floor covering in the same way as vinyl sheet flooring in roll form.

A floor covering can be provided comprising a decorative sheet or a plurality of decorative panels as in any embodiment of the first aspect of the invention. The decorative sheet or the decorative panels can be loose laid onto the underground. It is also possible to glue the decorative sheet of the decorative panels onto the underground. Alternatively, the decorative sheet or the decorative panels can be glued onto an underlay.

A decorative panel as in any embodiment of the first aspect of the invention can comprise a permanently bent shape or can be deformed permanently under an angle. The permanently bent shape or permanent deformation can provide an angle of 90°.

Such permanently bent or permanently deformed decorative panels can be used e.g. in furniture, e.g. providing the combination of a top panel and a side panel of a cabinet, or a curved top panel of a cabinet. The time required to assemble pieces of furniture comprising such permanently bent or permanently deformed decorative panels is reduced.

The permanently bent shape of permanently deformed shape can be obtained by bending or curving an originally flat panel using heat and pressure, wherein the heat provides a softening and/or melting of the halogen-free thermoplastic binder. thereby forming an originally flat panel into the desired shape.

An aspect of the invention is a piece of furniture, whether in in assembled condition or as flat pack furniture, comprising a decorative panel according to the invention and having a permanently bent shape or can be deformed permanently under an angle; wherein the permanently bent shape or permanent deformation can provide an angle of 90°.

The second aspect of the invention is a method for producing a sheet or panel, optionally a method for producing a decorative sheet or decorative panel as in any embodiment of the first aspect of the invention. The method is characterized in that the method comprises the steps of:
scattering core layer particles and particles of a thermoplastic or elastomeric halogen-free binder onto a continuously moving transport device, thereby forming a core layer of a mat of particles on the transport device;
consolidating the mat using heat and pressure, preferably in a double belt press, thereby obtaining a consolidated substrate less than 5 mm thick, preferably less than 4.5 mm thick, more preferably less than 3.5 mm thick, and more preferably less than 3 mm thick.

The core layer particles are selected from wood particles—preferably wood chips and/or wood fibers—, cellulosic particles and cork particles, or a combination thereof.

This method is an economic method for producing a decorative sheet or decorative panel as in the first aspect of the invention. The method provides a method for producing a thin panel which is not based on polyvinyl chloride.

A preferred method is characterized in that the method comprises the step of adding an additional binder to the core layer particles, wherein the additional binder is a thermoset binder, preferably selected from the list of polyurethane, hyperbranched polyamide, thermoset polyester or mixtures thereof.

The addition of the thermoset additional binder allows to obtain a more rigid sheet or panel.

More preferably, the relative amount of the additional binder in the combination of the halogen-free binder and the additional binder is between 1 and 15 mass percent.

The optional thermoset binder is preferably added to the core layer particles before the scattering operation, more preferably by means of a spraying operation. Such embodiments are preferred as improved distribution of the thermoset binder is obtained.

The particles of the thermoplastic or elastomeric halogen-free binder can be added to the core layer particles, preferably before scattering the core layer particles onto the continuously moving transport device. Such embodiments allow for a good and uniform distribution of both types of particles in the final product.

Such addition of the particles of the thermoplastic or elastomeric halogen-free binder to the core layer particles is preferably performed by mixing the core layer particles with the particles of a thermoplastic or elastomeric halogen-free binder. Such embodiments allow for an optimum distribution of both types of particles in the final product.

In a preferred method, the core layer particles and the particles of the thermoplastic or elastomeric halogen-free binder are scattered as a mixture; ensuring uniform distribution of the two types of particles, and resulting in reduced complexity of the scattering equipment.

The thermoplastic or elastomeric halogen-free binder is preferably selected from the list of polyvinyl butyral (PVB), styrene butadiene copolymer, ethylene vinyl acetate (EVA), polylactic acid (PLA), vinyl acetate-ethylene-vinyl ester copolymers, biobased polyester—e.g. polyhydroxyalkanoates—, thermoplastic polyurethanes, starch, polyolefines or mixtures thereof.

Such binders are preferred because they do not contain harmful plasticizers. It is a further benefit that these binders do not contain halogens. The use of biobased polyester has the benefit that it is biodegradable and that a larger percentage of material used is bio-based besides the core layer particles which are bio-based.

It is a benefit of the use of polyvinyl butyral (PVB) that PVB can be obtained from end-of-life wind shields of cars, resulting in re-use of the PVB, contributing in more eco-friendly production.

Reinforcement fibers and/or fillers can be added in the core layer.

A preferred method is characterized in that in the combination of the core layer particles and the thermoplastic or elastomeric halogen-free binder, the mass percentage of the halogen-free binder is at least 30%, and preferably more than 45%. A water resistant panel or sheet is manufactured this way.

A particularly preferred method is characterized in that before the step of scattering the core layer particles and the particles of a thermoplastic or elastomeric halogen-free binder; the method comprises the step of scattering a first layer of first layer particles and first layer binder onto the continuously moving transport device thereby forming a first layer in the mat of particles on the transport device. The first layer binder is a thermoplastic or elastomeric halogen-free binder. The first layer particles are selected from wood particles—preferably wood chips and/or wood fibers—, cellulosic particles and cork particles, or combinations thereof.

The provision of such first layer allows to tailor and optimize the properties—e.g. the mechanical properties—of the sheet or panel made in the method according to the second aspect of the invention.

The optional provision of a first layer also allows to select the composition and the properties of the core layer more freely.

The mass percentage of the first layer binder in the first layer is preferably lower than the mass percentage of the thermoplastic or elastomeric halogen-free binder of the core layer.

The first layer is scattered first in the scattering operation in the manufacturing process for manufacturing the sheet or panel. The layer scattered first contacts the surface of the continuously moving transport device onto which the scattering is performed. Providing such first layer comprising a lower mass percentage of binder compared to the core layer prevents adhesion of the sheet or panel being formed onto the surface of the continuously moving transport device. The particles for the core layer can then be scattered onto the particles forming the upper layer without risk of stickiness of adhesion to the surface of the continuously moving transport device.

The first layer binder preferably has the same chemical composition as the thermoplastic or elastomeric halogen-free binder of the core layer. Such embodiments provide reduced complexity in the composition of the sheet or panel, facilitating its recycling at its end-of-life or of production waste.

Optionally, a first layer thermoset binder can be provided in the first layer. It is a benefit of such embodiments that the amount of first layer binder can be reduced, further reducing the stickiness risk.

The optional first layer thermoset binder can be selected from the list of polyurethane, hyperbranched polyamide, thermoset polyester or mixtures thereof.

When a thermoset binder is used in the core layer, the first layer thermoset binder is preferably the same as the thermoset binder, but preferably in higher mass percentage in the respective layer.

Use of a first layer thermoset binder which is the same as a thermoset binder in the core layer has the benefit that the material composition of the sheet or panel is less complex, facilitating its recycling.

The core layer preferably contacts the optional first layer.

A particularly preferred method is characterized in that after the step of scattering the core layer particles and the particles of the thermoplastic or elastomeric halogen-free binder; and before the step of consolidating the mat under the influence of heat and pressure; the method comprises the step of scattering another layer of another layer particles and of another layer binder onto the continuously moving transport device thereby forming another layer in the mat of particles on the transport device. The another layer binder is a thermoplastic or elastomeric halogen-free binder. The another layer particles are selected from wood particles—preferably wood chips and/or wood fibers—, cellulosic particles and cork particles, or combinations thereof.

The provision of such another layer allows to tailor and optimize the properties—e.g. the mechanical properties—of the sheet or panel made in the method according to the second aspect of the invention.

The optional provision of the another layer also allows to select the composition and the properties of the core layer more freely.

The mass percentage of the another layer binder in the another layer is preferably lower than the mass percentage of the thermoplastic or elastomeric halogen-free binder of the core layer.

Preferably the another layer binder has the same chemical composition as the thermoplastic or elastomeric halogen-free binder of the core layer. Such embodiments provide reduced complexity in the composition of the sheet or panel, facilitating its recycling at its end-of-life or of production waste.

Optionally, an another layer thermoset binder is provided in the another layer.

The optional another layer thermoset binder can be selected from the list of polyurethane, hyperbranched polyamide, thermoset polyester or mixtures thereof.

When a thermoset binder is used in the core layer, the another layer thermoset binder is preferably the same as the thermoset binder, but preferably in higher mass percentage in the respective layer.

When an optional first layer is provided comprising an optional first layer thermoset binder, preferably the another layer thermoset binder is the same as the first layer thermoset binder. Such embodiments have the benefit that the composition of the sheet or panel is less complex, facilitating its recycling.

The core layer preferably contacts the optional another layer.

A preferred method is characterized in that in line with the consolidation of the mat using heat and pressure, the method comprises the step of laminating a decor layer, and optionally a wear layer, onto the consolidated substrate. Such method provides an efficient and economical way of manufacturing a decorative sheet or a decorative panel.

The decor layer can comprise a decor printed onto a paper sheet or onto a polymer sheet.

The decor layer can be laminated onto the consolidated substrate using an adhesive, e.g. a polyurethane adhesive.

The decor layer is provided by a High Pressure Laminate (HPL) or a Continuous Pressure Laminate (CPL) laminated onto the consolidated substrate.

The method can comprises the step of laminating a balancing layer onto the bottom of the consolidated substrate.

Preferably laminating the optional balancing layer is provided using the same adhesive as in laminating the optional décor layer onto the consolidated substrate. Such embodiments provide a sheet or panel with improved dimensional stability.

A preferred method is characterized in that a decor layer and a wear layer is laminated onto the consolidated substrate, wherein the wear layer comprises a thermoplastic film—optionally comprising a lacquer layer (e.g. an acrylic lacquer layer)—, or a resin impregnated paper layer.

The optional step of lamination a decor layer and a wear layer onto the consolidated substrate is preferably carried out in a second press—more preferably in a double belt press—, or in a laminator. Such embodiments allow to optimize the production speeds of the different operations in the method, more specifically the scatting and consolidation process on the one hand and the lamination process on the other hand.

One or more than one lacquer layer (e.g. one or more acrylic lacquer layer) can be applied onto the sheet or panel, and cured; preferably in line with the lamination step.

After consolidating the mat under the influence of heat and pressure, the method of the second aspect of the invention can comprise the step of direct digital printing a design onto the consolidated substrate. It means that no separate carrier is required for the printed décor, reducing the complexity of the composition of the sheet or panel.

A preferred method comprises the step of applying one or more than one lacquer layer (e.g. one or more than one acrylic lacquer layer) on top of a printed design.

The third aspect of the invention is a layered panel, characterized in that the layered panel comprises at least on the one hand a carrier layer, and on the other hand a decorative sheet or decorative panel as in any embodiment of the first aspect of the invention.

It is a benefit of such layer panel that a light weight panel can be provided that has excellent mechanical properties, and which is not noisy when walked upon when used as floor covering.

The carrier layer can be made out of cheaper material than the decorative sheet or decorative panel.

The carrier layer provides rigidity to the layered panel.

It is a further benefit that layered panels can be provided that have good sound dampening properties, and which use eco-friendly and/or recycled materials to a large extent.

A preferred layered panel is characterized in that the thickness of the decorative sheet or decorative panel is less than 40% of the thickness of the layered panel. More preferably, the thickness of the decorative sheet or decorative panel is less than 30% of the thickness of the layered panel, even more preferably the thickness of the decorative sheet or decorative panel is less than 20% of the thickness of the layered panel.

A preferred layered panel is characterized in that the carrier layer comprises or consists of a particle board, preferably a wood particle board. Such embodiments have the benefit that noise issues are even better prevented.

The thickness of the particle board can preferably at least 8 mm, and even more preferably at least 10 mm.

A preferred layered panel wherein the carrier layer comprises or consists of a particle board is characterized in that the particle board comprises wood chips bonded at least partially—and preferably fully—by means of a thermoset resin. Such products can be easily produced at an interesting cost.

The thermoset resin is preferably selected from the list of urea formaldehyde resin, melamine urea formaldehyde resin, polyurethane, a diisocyanate (e.g. methylene diphenyl diisocyanate), or the combination of a diisocyanate (e.g. methylene diphenyl diisocyanate) on the one hand and on the other hand a diol or polyol.

A preferred layered panel wherein the carrier layer comprises or consists of a particle board is characterized in that the particle board comprises or consists of a first particle board layer and a second particle board layer. The first particle board layer is provided closer to the decorative sheet or the decorative panel than the second particle board layer. The second particle board layer comprises on weight average basis finer wood chips than the first particle board layer.

Such embodiments have the benefit that coupling parts can be milled into the second particle board layer and into the substrate of the decorative sheet or decorative panel. This results in more sturdy coupling parts. Such coupling parts can be used for coupling neighboring layered panels when used in e.g. a floor covering.

More preferably, the substrate of the decorative sheet or decorative panel comprises wood chips; which are more preferably on weight average basis finer wood chips than the wood chips of the first particle board layer.

Such embodiment results in even more sturdy coupling parts.

A preferred layered panel wherein the carrier layer comprises or consists of a particle board is characterized in that the particle board comprises or consists of a first particle board layer, a second particle board layer and a third particle board layer. The third particle board layer is provided closer to the decorative sheet or the decorative panel than the second particle board layer. The first particle board layer is provided between the second particle board layer and the third particle board layer. The first particle board layer comprises on weight average basis coarser wood chips than the second particle board layer and than the third particle board layer.

Such embodiments have the benefit that coupling parts can be milled into the second particle board layer and into the third particle board layer. This results in more sturdy coupling parts. Such coupling parts can be used for coupling neighboring layered panels when used in e.g. a floor covering.

A preferred layered panel wherein the carrier layer comprises or consists of a particle board is characterized in that the wood chips of the second particle board layer are at least partly bonded by means of a thermoplastic or elastomeric halogen-free binder. It is meant that besides the thermoplastic or elastomeric halogen-free binder a thermoset binder can be present. However, this is not necessarily the case. It is possible that the second particle board layer does not comprise a thermoset binder; and that the wood chips of the second particle board layer are fully bonded by means of a thermoplastic or elastomeric halogen-free binder.

It is a benefit of such embodiments that the first layer, and/or if present the third layer can have the same composition, in terms of binder composition, and optionally also in types and size of wood particles. Such embodiments facilitate the raw material preparation and handling.

It is a benefit of such embodiments that the layered panel will generate less noise when being walked upon when being used in a floor covering.

Preferably the thermoplastic or elastomeric halogen-free binder of the second particle board layer is selected from the list of polyvinyl butyral (PVB), styrene butadiene copolymer, ethylene vinyl acetate (EVA), polylactic acid (PLA), vinyl acetate-ethylene-vinyl ester copolymers, biobased polyester—e.g. polyhydroxyalkanoates—, thermoplastic polyurethanes, starch, polyolefines or mixtures thereof.

In embodiments wherein the wood chips of the second particle board layer are at least partly bonded by means of a thermoplastic or elastomeric halogen-free binder, the wood chips of the second particle board layer can be partly bonded by an additional binder, wherein the additional binder is selected from the list of thermoset binder (e.g. an urea formaldehyde resin or a melamine urea formaldehyde resin), polyurethane, hyperbranched polyamide, thermoset polyester or mixtures thereof. Preferably, the relative amount of the additional binder in the combination of the thermoplastic of elastomeric halogen-free binder and the additional binder is between 1 and 15 mass percent.

It is a benefit of such embodiments that the first layer, and/or if present the third layer can have the same composition, in terms of binder composition, and optionally also in type and size of wood particles. Such embodiments facilitate the raw material preparation and handling.

It is a benefit of such embodiments that the layered panel will generate less noise when being walked upon when being used in a floor covering.

A preferred layered panel is characterized in that it is rectangular and has a length direction, wherein the carrier layer comprises a multitude of laths, adjacent to each other, wherein the longitudinal direction of the laths is provided in the transverse direction of the layered panel.

More preferably, the laths are wooden laths, more preferably out of bamboo wood or out of hevea wood

Preferably, the thickness of the laths is at least 50%—and preferably at least 60%—of the thickness of the layered panel. This way, the laths provide optimal rigidity to the layered panel.

The carrier layer can comprise a wood board, more preferably a board of solid wood, even more preferably a board of fast growing wood, e.g. bamboo, and/or spruce and/or hevea. Such embodiments provide a cheap way of providing a carrier layer.

The thickness of the optional wood board can be at least 50%—and preferably at least 60%—of the thickness of the layered panel. This way, optimal rigidity is provided to the layered panel.

The carrier layer can comprise or consist of a wood fiber board, e.g. a Medium Density Fiberboard (MDF) or a High Density Fiberboard (HDF). Such embodiments have shown to provide excellent properties to the layered panel.

The thickness of the wood fiber board can be at least 50%—and preferably at least 60%—of the thickness of the layered panel. This way, optimal rigidity is provided to the layered panel.

In preferred embodiments of the third aspect of the invention, the carrier layer comprises a layer of wood on one side—either on the side on which the decorative sheet or the decorative panel is provided, or on the opposite side of the side on which the decorative sheet or the decorative panel is provided—or on both sides.

A preferred embodiment of the third aspect of the invention is characterized in that the carrier layer comprises or consists of a mineral board. Such layered panels can be used as floor covering. It is a benefit of such floor covering that its comprises mineral boards—providing the benefits of a floor covering comprising mineral boards—but that less noise is generated when the floor covering is being walked upon.

The mineral board can preferably be selected from a magnesium oxide board, a cement-based board, a fiber cement board, a geopolymer board, a gypsum-based board or a gypsum fiber board.

In a preferred embodiment, the layered panel comprises at the side opposite to the side comprising the sheet or panel, a backing layer, preferably wherein the backing layer comprises or consists of a wood layer—e.g. a wood veneer layer—or a paper layer impregnated with melamine resin.

A preferred layered panel is characterized in that the decorative sheet or decorative panel is bonded into the layered panel by means of a layer of adhesive, preferably wherein the adhesive is selected from polyurethane (e.g. reactive polyurethane), ethylene vinyl acetate (EVA), or polyvinyl acetate (PVAc).

A preferred layered panel is characterized in that the layered panel is rectangular—square or oblong—, wherein the layered panel comprises at least at two opposite side edges coupling parts for coupling the layered panel with a second such layered panel at their respective side edges; wherein in coupled condition a locking is provided in the direction perpendicular to the surface of the coupled layered panels; as well as a locking is provided in the direction perpendicular to the coupled side edges and parallel to the surface of the coupled layered panels; wherein the coupling parts comprise at one of the two opposite side edges a male coupling part; wherein the coupling parts comprise at the other one of the two opposite side edges a female coupling part.

Such embodiments have the benefit that the layered panels can be easily installed into a floor covering.

In more preferred embodiments, the male coupling part comprises a tongue; and the female coupling part comprises a groove, wherein the groove is bordered by an upper lip and by a lower lip; preferably wherein the lower lip extends more distal than the upper lip.

A preferred layered panel according to the third aspect of the invention is characterized in that the coupling parts are configured as on the one hand a tongue and on the other hand a groove bordered by an upper lip and a lower lip; wherein the tongue and the groove provide in coupled condition a locking in the direction perpendicular to the surface of the coupled layered panels. The tongue and the groove comprise locking parts, wherein the locking parts provide in coupled condition a locking in the direction perpendicular to the coupled side edges and parallel to the surface of the coupled layered panels. More preferably the locking parts comprise a protrusion at the lower lip and a corresponding recess at the bottom of the tongue.

Such embodiment provide for ease of installation and efficient and effective locking of the layered panels without the need of use of an adhesive.

A preferred layered panel is characterized in that the coupling can be performed by means of an angling movement of the respective side edges of the layered panels to be coupled. Layered panels according to such embodiments can be easily installed into a floor covering.

The optional coupling parts can be provided in the carrier layer. It means that the decorative sheet or the decorative panel is not affected by the provision of the coupling parts, and does not need to have properties that allow coupling parts to be made (e.g. by means of milling) into the decorative sheet or the decorative panel.

The fourth aspect of the invention is a method for manufacturing a layered panel, optionally a layered panel as in any embodiment of the third aspect of the invention. The method of the fourth aspect of the invention comprises the steps of providing a carrier layer, providing a substrate, providing a décor layer; and stacking the substrate onto the carrier layer and the décor layer onto the substrate, thereby forming a stack comprising the substrate, the carrier layer and the décor layer. The method further comprises the step of laminating the stack by means of a press operation at elevated temperature. The substrate comprises or consists of a core layer; and optionally an upper layer and/or a lower layer. The core layer comprises core layer particles and a thermoplastic or elastomeric halogen-free binder. The core layer particles are selected from wood particles—preferably wood chips and/or wood fibers—, cellulosic particles and cork particles, or a combination thereof. The substrate comprises a layer of adhesive on its surface directed to the carrier layer and/or the carrier layer comprises a layer of adhesive on its surface directed to the substrate and/or a layer of adhesive is provided in the stack between and contacting both the carrier layer and the substrate.

The layer of adhesive is provided for bonding the substrate to the carrier layer.

The method of the fourth aspect of the invention has the benefit that a very elegant method is provided for manufacturing a layered, decorative panel having improved sound dampening properties. The improved sound dampening properties are especially noticed when walking upon a floor covering installed using layered panels made according to the method of the fourth aspect of the invention. The substrate—and its positioning in the layered panel—provides to a large extent for the sound dampening properties.

The separate production of the substrate provides for optimized production of the substrate. The lamination step of the method of the fourth aspect of the invention provides for production of the layered panel with a minimum of production steps.

A preferred embodiment of the fourth aspect of the invention is characterized in that the step of lamination is performed in a single daylight press. Such embodiment provides a very efficient lamination and allows—by using a structured press element—for providing a texture at the decorative surface of the layered panel. It is even possible to obtain a texture in register with the printed décor of the décor layer.

A preferred embodiment of the fourth aspect of the invention is characterized in that the adhesive of the layer of adhesive is selected from polyurethane (e.g. reactive polyurethane), ethylene vinyl acetate (EVA), or polyvinyl acetate (PVAc).

Such adhesives provide an excellent bonding strength to the layers of the layered panel.

A preferred embodiment of the fourth aspect of the invention is characterized in that the thermoplastic or elastomeric halogen-free binder is selected from the list of polyvinyl butyral (PVB), styrene butadiene copolymer, ethylene vinyl acetate (EVA), polylactic acid (PLA), vinyl acetate-ethylene-vinyl ester copolymers, biobased polyester—e.g. polyhydroxyalkanoates—, thermoplastic polyurethanes, starch, polyolefines or mixtures thereof.

Such binders are preferred because they do not contain harmful plasticizers. It is a further benefit that these binders do not contain halogens. The use of biobased polyester has the benefit that it is biodegradable and that a larger percentage of material used is bio-based besides the core layer particles which are bio-based.

Furthermore, such adhesives have the benefit that excellent sound dampening properties are provided to the layered panel.

It is a benefit of the use of polyvinyl butyral (PVB) that PVB can be obtained from end-of-life wind shields of cars, resulting in re-use of the PVB, contributing in more eco-friendly production.

It is a benefit of the use of styrene butadiene copolymer that the core layer can be produced via extrusion.

A preferred embodiment of the fourth aspect of the invention is characterized in that the core layer comprises an additional binder, wherein the additional binder is selected from the list of thermoset binder, polyurethane, hyperbranched polyamide, thermoset polyester or mixtures thereof.

Such embodiments are preferred, as a more rigid layered panel is obtained while the layered panel has excellent sound dampening properties.

The use of polyurethane as additional binder is particularly preferred, as it results in an even more rigid layered panel with good sound dampening properties.

More preferably, the relative amount of the additional binder in the combination of the halogen-free binder and the additional binder is between 1 and 15 mass percent.

The weight percentage of the thermoplastic or elastomeric halogen-free binder in the core layer can preferably be at least 30%; and preferably more than 45%. It is a benefit of such embodiments that an improved resistance to water is obtained, improving the durability of the layered panel.

A preferred embodiment of the fourth aspect of the invention is characterized in that the core layer comprises reinforcement fibers, preferably selected from glass fibers, polyvinyl alcohol fibers or basalt fibers; preferably wherein the core layer comprises between 0.5 and 8 percent by mass of reinforcement fibers.

A preferred embodiment of the fourth aspect of the invention is characterized in that the core layer comprises fillers, preferably wherein the fillers are selected from perlite, expanded glass particles, calcium carbonate, or talc; or a combination thereof.

A preferred embodiment of the fourth aspect of the invention is characterized in that the core layer comprises a plasticizer, preferably a biobased plasticizer or a protein based plasticizer, e.g. gluten.

The incorporation of plasticizers has the benefit that the flexibility of the bonding of the core layer is improved, for optimized functionality of the product obtained in the method.

The plasticizer can be selected from ortho phthalates such as DINP (diisononyl phthalate, DPHP), di(2-propylheptyl) phthalate; terephthalates such as DOTP (dioctyl terephthalate or DBT (dibutyl terephthalates); (cyclo) hexanoates such as DINCH, 1,2-cyclohexane dicarboxylic acid diisononyl ester; adipates such as DOA (dioctyl adipate); benzoates such as IDB (isodecyl benzoate), and vegetable oil based plasticizers such as ESBO.

Biobased plasticizers or a protein based plasticizer, e.g. gluten, are particularly preferred as they are not harmful, and as they are biobased.

A preferred embodiment of the fourth aspect of the invention is characterized in that the substrate comprises an upper layer directed in the stack towards the decor layer; wherein the upper layer comprises upper layer particles and an upper layer binder. The upper layer particles are selected from wood particles—preferably wood chips and/or wood fibers—, cellulosic particles, and cork particles, or combinations thereof. The upper layer binder is a thermoplastic or elastomeric halogen-free binder. Preferably, the mass percentage of the upper layer binder in the upper layer is lower than the mass percentage of the thermoplastic or elastomeric halogen-free binder of the core layer; and/or preferably the upper layer binder has the same chemical composition as the thermoplastic or elastomeric halogen-free binder of the core layer. The upper layer can optionally comprise a thermoset upper layer binder. The upper layer preferably contacts the core layer.

Such embodiments have the benefits as described for the similar embodiments of the first aspect of the invention.

A preferred embodiment of the fourth aspect of the invention is characterized in that the substrate comprises a lower layer at the other side of the core layer than the side directed to the decor layer. The lower layer comprises lower layer particles and a lower layer binder. The lower layer particles are selected from wood particles—preferably wood chips and/or wood fibers—, cellulosic particles and cork particles or combinations thereof. The lower layer binder is a thermoplastic or elastomeric halogen-free binder. Preferably, the mass percentage of the lower layer binder in the lower layer is lower than the mass percentage of the thermoplastic or elastomeric halogen-free binder of the core layer; and/or preferably, the lower layer binder has the same chemical composition as the thermoplastic or elastomeric halogen-free binder of the core layer. The lower layer optionally comprises a thermoset lower layer binder.

Such embodiments have the benefits as described for the similar embodiments of the first aspect of the invention.

A preferred embodiment of the fourth aspect of the invention is characterized in that the decor layer comprises a decor printed onto a carrier sheet, e.g. wherein the carrier sheet comprises a paper sheet or a polymer foil.

Such embodiments provide an easy way of laminating the décor layer into the layered panel made with the method of the fourth aspect of the invention.

A preferred embodiment of the fourth aspect of the invention is characterized in that the décor layer comprises a resin impregnated printed paper sheet; preferably wherein the resin of the resin impregnated printed paper sheet comprises an acrylate resin or a melamine formaldehyde resin.

Such embodiments provide an easy way of laminating the décor layer into the layered panel made with the method of the fourth aspect of the invention.

Preferably, the resin—e.g. an acrylate resin—of the resin impregnated printed paper sheet is not fully cured. Such embodiment has the benefit that the resin can provide adhesive properties towards the substrate and/or that a surface texture can be provided during the press operation at elevated temperature.

In embodiments wherein the resin of the resin impregnated printed paper sheet comprises an acrylate resin, the acrylate resin preferably comprises a thermo-initiator. It is a benefit of such embodiments that the thermo-initiator will initiate curing of the acrylate resin during the press operation at elevated temperatures. It allows that when using a structured press element, a texture can be provided in the surface of the product made.

A preferred embodiment of the fourth aspect of the invention is characterized in that the décor layer comprises an added layer of adhesive on its surface directed to the substrate and/or the substrate comprises an added layer of adhesive on its surface directed to the décor layer and/or an added layer of adhesive is provided in the stack between and contacting both the décor layer and the substrate.

Such embodiments allow to laminate the layers of different nature in an efficient way to each other.

A preferred embodiment of the fourth aspect of the invention is characterized in that the adhesive of the added layer of adhesive is selected from polyurethane (e.g. reactive polyurethane), ethylene vinyl acetate (EVA), or polyvinyl acetate (PVAc).

Such embodiments allow to laminate the layers of different nature in an efficient way to each other.

The décor layer can be a High Pressure Laminate (HPL) or a Continuous Pressure Laminate (CPL).

Such décor layers are well suited for being incorporated in a layered panel according to a method according to the fourth aspect of the invention.

A preferred embodiment of the fourth aspect of the invention is characterized in that the method comprises the step of providing a wear layer, wherein the wear layer is applied onto the décor layer; or wherein the wear layer is stacked onto the décor layer such that the stack comprises the substrate, the carrier layer, the décor layer and the wear layer.

The method of the fourth aspect of the invention is optimally suited to manufacture layered panels comprising a wear layer. The wear layer can be present on the décor layer already before the stacking and lamination step, or the wear layer can be incorporated in the stack as a separate layer before the pressing operation.

The wear layer can comprise a lacquer layer, or a thermoplastic film—optionally comprising a lacquer layer—, or a resin impregnated paper layer.

The wear layer can be provided as a lacquer layer on the décor layer. In such embodiments, the décor layer and the wear layer are put in the stack as one single layer.

Alternatively, the wear layer can be a layer separate from the décor layer. The décor layer can e.g. be a resin impregnated paper layer, e.g. impregnated with a melamine resin or with an acrylate resin.

The resin of the resin impregnated paper layer providing the wear layer and/or the lacquer providing the wear layer are preferably not fully cured. Such embodiments have the benefit that the resin or the lacquer can provide adhesion to the layer contacting the wear layer and/or that a surface texture can be pressed during the thermal pressing operation.

Preferably the resin—e.g. an acrylate resin—of the resin impregnated paper layer providing the wear layer and/or the lacquer providing the wear layer is preferably not fully cured and comprises a thermo-initiator. It is a benefit that the thermo-initiator will initiate curing of the resin or of the lacquer during the press operation at elevated temperature. Such embodiments have the benefit that the resin or the lacquer can provide adhesion to the layer contacting the wear layer and/or that a surface texture can be pressed during the press operation at elevated temperature.

A preferred embodiment of the fourth aspect of the invention is characterized in that in the press operation at elevated temperature a texture is pressed in the layered panel, preferably a texture is register with the printed décor of the décor layer.

Such embodiments provide an economical way of providing a texture, and preferably a texture in register with a printed décor, to the layered panel, as no separate production step is required for providing the texture.

Preferred embodiments of the fourth aspect of the invention are characterized in that the carrier layer is a carrier layer as specified in any embodiment of the third aspect of the invention.

The carrier layer of particularly preferred embodiments of the fourth aspect of the invention comprises of consists of a wood particle board or a wood fiber board (e.g. a Medium Density Fiberboard or a High Density Fiberboard).

Wood particle boards and wood fiber boards have the benefit that they are made with recycled wood and/or with wood not suitable for other value adding wood products. Furthermore; as the substrate comprises core layer particles selected from wood particles—preferably wood chips and/or wood fibers—cellulosic particles and cork particles, or combinations thereof, the core layer particles are of the same chemical nature as the wood chips or wood fibers of the carrier layer, facilitating recycling of the layered panel into valuable wood particle products.

Particularly preferred particle boards for use as carrier layer in the method of the fourth aspect of the invention are particle boards described as carrier layer in the third aspect of the invention.

A preferred embodiment of the fourth aspect of the invention is characterized in that the thickness of the substrate is less than 40% of the thickness of the layered panel. More preferably, the thickness of the substrate is less than 30% of the thickness of the layered panel. Even more preferably the thickness of the substrate is less than 20% of the thickness of the layered panel.

Such embodiments are preferred as a layered panel with excellent mechanical properties is obtained with excellent sound dampening properties. The sound dampening properties are to a large extent provided by the substrate, which does not need to have a large relative thickness of the layered panel.

A preferred embodiment of the fourth aspect of the invention is characterized in that the carrier layer provides at least 60%, and more preferably at least 70, of the thickness of the layered panel.

Such embodiments are preferred as a layered panel with excellent mechanical properties is obtained with excellent sound dampening properties. The sound dampening properties are to a large extent provided by the substrate, which does not need to have a large relative thickness of the layered panel.

A preferred embodiment of the fourth aspect of the invention is characterized in that the method comprising the steps of providing a balancing layer, and placing—prior to the lamination step—the balancing layer in the stack at the other side of the carrier layer than the side where the substrate is provided; and laminating the balancing layer in the press operation at elevated temperature.

Such balancing layer can contribute to the dimensional stability of the layered panel. It is a further benefit of such embodiment that no additional production step is required for incorporating the balancing layer into the layered panel.

Embodiments of the fourth aspect of the invention have the benefit that a layered panel can be made that is not comprising melamine.

Embodiments of the fourth aspect of the invention have the benefit that a layered panel can be made that is not comprising formaldehyde.

With the intention of better showing the characteristics of the invention, hereafter, as an example without any limitative character, several preferred embodiments are described, with reference to the accompanying drawings, wherein:

FIG. 1 shows an example of a decorative sheet or decorative panel according to the invention;

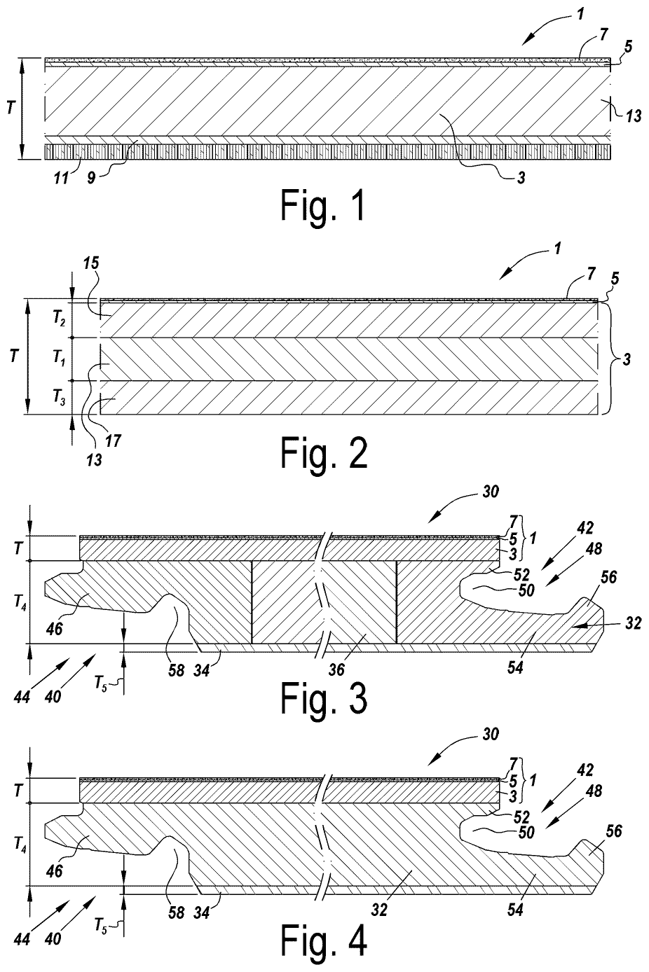

FIG. 2 shows another example of a decorative panel according to the invention;

FIG. 3 shows a layered panel according to the invention;

FIG. 4 shows another example of a layered panel according to the invention;

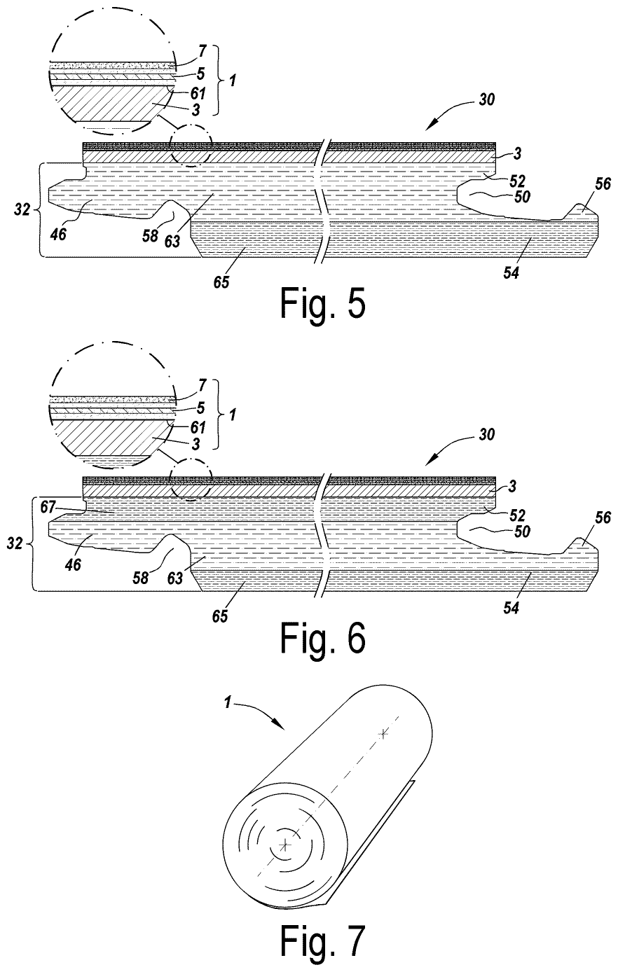

FIG. 5 shows another example of a layered panel according to the invention;

FIG. 6 shows another example of a layered panel according to the invention;

FIG. 7 shows a decorative sheet according to the invention provided as a roll;

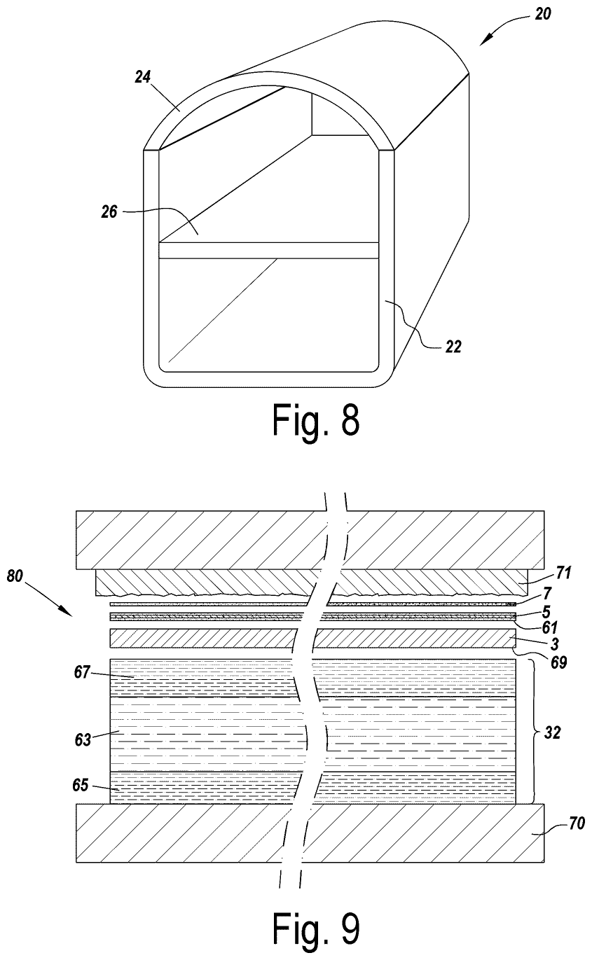

FIG. 8 shows the front view of a piece of furniture comprising a bent and a curved panel according to the invention; and

FIG. 9 illustrates an embodiment of the method according to the fourth aspect of the invention.

FIG. 1 shows an example of a decorative sheet or decorative panel 1 according to the invention. The decorative panel 1 has a thickness T equal to 3.5 mm. The decorative panel 1 comprises a substrate 3 and a decor layer 5. Although not essential for the invention, the decorative panel 1 of FIG. 1 also comprises an optional wear layer 7, an optional balancing layer 9 and an optional resilient pad attach bottom layer 11.

The substrate 3 consists of a core layer 13. The core layer 13 comprises core layer particles and a thermoplastic halogen-free binder. In the example, the core layer particles are wood chips. In the example shown, the thermoplastic halogen-free binder is polyvinyl butyral (PVB). The core layer 13 consists of 45 wt % polyvinyl butyral (PVB) and 55 wt % wood chips.

The decor layer 5 comprises a decor printed onto a paper sheet. This paper sheet, with its printed décor, can be laminated onto the substrate by means of an adhesive; e.g. a polyurethane adhesive. The optional balancing layer 9 of the example is a resin impregnated paper sheet laminated into the decorative panel 1 using the same type of adhesive as used for laminating the décor layer.

The optional wear layer 7 can e.g. be provided by a lacquer layer (e.g. an acrylic lacquer layer) or by a resin impregnated paper layer (e.g. impregnated with an acrylic resin).

The decorative panel 1 comprises a textured surface, obtained by an embossing operation. The texturing of the surface is in register with the printed décor.

Other methods for establishing a décor layer are possible.

The decorative panel 1 of FIG. 1 can be used as a floor covering.

FIG. 2 shows another example of a decorative panel 1 according to the invention. The panel 1 comprises a substrate 3 and a decor layer 5. The decorative panel 1 of FIG. 2 also comprises an optional wear layer 7.

The substrate 3 consists of a core layer 13, an upper layer 15 and a lower layer 17. The core layer 13 has thickness T1 of 1.5 mm, the upper layer 15 has thickness T2 of 1.2 mm, and the lower layer 17 has thickness T3 of 1.2 mm. The total thickness T of the panel is 4.0 mm.

The core layer 13 comprises core layer particles and a thermoplastic halogen-free binder. In the example, the core layer particles are wood chips, however, other core layer particles are possible. The thermoplastic halogen-free binder of the core layer 13 is polyvinyl butyral (PVB), however other thermoplastic or elastomeric halogen-free binders are possible. The core layer 13 consists of 45 wt % polyvinyl butyral (PVB) and 55 wt % wood chips.

The upper layer 15 is provided between the core layer 13 and the decor layer 5. The upper layer 15 contacts the décor layer 5. The upper layer 15 comprises upper layer particles and an upper layer binder. In the example shown, the upper layer particles are wood chips, however, other upper layer particles can be used in the invention. The upper layer binder is a thermoplastic or elastomeric halogen-free binder. In the example shown, polyvinyl butyral (PVB) has been used as upper layer binder. Other thermoplastic or elastomeric halogen-free binders can be used however. The upper layer 15 of the example also comprises a urea-formaldehyde resin as thermoset upper layer binder. The upper layer 15 comprises 35 wt % polyvinyl butyral (PVB), 60 wt % wood chips and 5 wt % urea-formaldehyde resin.

In producing the panel, the upper layer is provided by means of scattering a mixture of particles. The mixture consists of polyvinyl butyral (PVB) particles and wood chips onto which the urea-formaldehyde resin has been applied.

The lower layer 17 contacts the core layer 13. The lower layer 17 comprises lower layer particles and a lower layer binder. In the example shown, the lower layer particles are wood chips, however, other lower layer particles can be used in the invention. The lower layer binder is a thermoplastic or elastomeric halogen-free binder. In the example shown, polyvinyl butyral (PVB) has been used as lower layer binder. Other thermoplastic or elastomeric halogen-free binders can be used however. The lower layer 15 of the example also comprises a urea-formaldehyde resin as thermoset lower layer binder.

The lower layer 17 comprises 35 wt % polyvinyl butyral (PVB), 60 wt % wood chips and 5 wt % urea-formaldehyde resin. In the example, the lower layer 17 has the same composition and the same thickness as the upper layer 15. However, this is not necessary the case in the invention.

In the example of FIG. 2, the lower layer 17 provides the bottom of the decorative panel 1.

The decorative panel 1 of FIG. 2 can be used as a floor covering.

FIG. 3 shows an example of a layered panel 30 according to the invention. The layered panel is rectangular and comprises a carrier layer 32, a decorative panel 1 as in the first aspect of the invention, and a backing layer 34. The carrier layer 32, the decorative panel 1 and the backing layer 34 are laminated to each other using an adhesive, e.g. a reactive polyurethane adhesive (PUR). Other adhesives can be used.

The panel 1 has a thickness T equal to 3 mm. The panel 1 comprises a substrate 3, a decor layer 5 and a wear layer 7. The substrate 3 consists of a core layer 13. The core layer 13 comprises core layer particles and a thermoplastic halogen-free binder. In the example, the core layer particles are wood chips (however, other core layer particles are possible). In the example shown, the thermoplastic halogen-free binder is polyvinyl butyral (PVB); however, other thermoplastic or elastomeric halogen-free binders can be used. The core layer 13 consists of 45 wt % polyvinyl butyral (PVB), 50.6 wt % wood chips and 4.4 wt % urea-formaldehyde resin (a thermoset binder).

The décor layer 5 and the wear layer 7 are embossed.

The rectangular layered panel 30 has a length direction. The carrier layer 32 comprises a multitude of laths 36, adjacent to each other. The longitudinal direction of the laths is provided in the transverse direction of the layered panel. In the example shown, the laths 36 are wooden laths, out of hevea wood.

In the example shown, the backing layer 34 is a layer of spruce wood.

In the example of FIG. 3, the decorative panel 1 has a thickness T of 3 mm,

The laths 36 have thickness T4 equal to 10 mm, and the backing layer 34 has thickness T5 equal to 1 mm.

The layered panel comprises at opposite side edges coupling parts 40, 42 for coupling the layered panel with a second such layered panel at their respective side edges. In coupled condition a locking is provided in the direction perpendicular to the surface of the coupled layered panels; as well as a locking is provided in the direction perpendicular to the coupled side edges and parallel to the surface of the coupled layered panels.

The coupling parts 40, 42 comprise at one of the two edges a male coupling part 44. The male coupling part comprises a tongue 46. The coupling parts comprise at the other one of the two edges a female coupling part 48 comprising a groove 50, which is bordered by an upper lip and 52 by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel to the surface of the coupled layered panels. In the example shown, the locking parts 56, 58 comprise a protrusion 56 at the lower lip 54, and a corresponding recess 58 at the bottom of the tongue 46.

The coupling parts 40, 42 are provided in the carrier layer 32. The coupling parts 40, 42 of the layered panel 30 of FIG. 3 are configured such that coupling can be performed by means of an angling movement of the respective side edges of the layered panels to be coupled.

The layered panel 30 of FIG. 3 can be used as a floor covering.

FIG. 4 shows another example of a layered panel 30 according to the invention. The layered panel 30 of FIG. 4 is to a large extent similar to the layered panel of FIG. 3.

Instead of a multitude of laths, adjacent to each other, the carrier layer 32 of the layered panel 30 consists of a board of solid wood, in the example shown spruce wood. The thickness T4 of the carrier layer 32 out of spruce wood is in the example equal to 1 mm.

FIG. 5 shows another example of a layered panel 30 according to the invention. The layered panel has a carrier layer 32, and a decorative panel 1. The decorative panel 1 is a panel as in the first aspect of the invention; which comprises in this example a substrate 3, a décor layer 5 and a wear layer 7.

The substrate 3 comprises wood chips, polyvinyl butyral (PVB) as a thermoplastic halogen-free binder and polyurethane as thermoset binder. In the example shown, the thermoplastic halogen-free binder is polyvinyl butyral (PVB).

In the example of FIG. 5, the décor layer 5 is a printed paper sheet impregnated with an acrylate resin.

The décor layer 5 is laminated onto the substrate 3 by means of a polyurethane adhesive 61.

The wear layer 7 is provided by an acrylic lacquer. The lacquer layer can optionally comprise wear resistant particles such as corundum particles.

The layered panel of FIG. 5 has a carrier layer 32 consisting of a particle board. The particle board has a first particle board layer 63 and a second particle board layer 65. The second particle board layer 65 comprises on weight average basis finer wood chips than the first particle board layer.

The substrate 3 is bonded to the first particle board layer 63.

The wood chips of the first particle board layer 63 can be bonded by means of a thermoset resin, e.g. by means of a urea formaldehyde resin or a melamine formaldehyde resin.

The wood chips of the second particle board layer 65 can be bonded by means of the same binder composition as the substrate 3. It is also possible that the wood chips of the second particle board layer 65 are bonded by a thermoset resin, e.g. by means of a urea formaldehyde resin or a melamine formaldehyde resin.

FIG. 6 shows another example of a layered panel 30 according to the invention.

The layered panel has a carrier layer 32, and a decorative panel 1. The decorative panel 1 is a panel as in the first aspect of the invention; which comprises in this example a substrate 3, a décor layer 5 and a wear layer 7.

The substrate 3 comprises wood chips and a thermoplastic halogen-free binder. In the example shown, the thermoplastic halogen-free binder is polyvinyl butyral (PVB). The substrate 3 consists of 45 wt % polyvinyl butyral (PVB) and 55 wt % wood chips. Optionally, the core layer can comprise a thermoset binder in addition to the thermoplastic halogen-free binder.

In the example of FIG. 6, the décor layer 5 is a printed paper sheet 5 impregnated with an acrylate resin.

The décor layer 5 is laminated to the substrate 3 by means of a polyurethane adhesive 61.

The wear layer 7 is provided by an acrylic lacquer. The lacquer layer can optionally comprise wear resistant particles such as corundum particles.

The layered panel 30 of FIG. 5 has a carrier layer 32 consisting of a particle board. The particle board has a first particle board layer 63, a second particle board layer 65, and a third particle board layer 67. The second particle board layer 65 comprises on weight average basis finer wood chips than the first layer 63. The third particle board layer 67 comprises on weight average basis finer wood chips than the first particle board layer 63. The size distribution of the wood chips of the third particle board layer can be the same as the size distribution of the wood chips of the first particle board layer.

The substrate 3 is bonded to the third particle board layer 67.

The wood chips of the first particle board layer 63 can be bonded by means of a thermoset resin, e.g. by means of a urea formaldehyde resin or a melamine formaldehyde resin.

The wood chips of the third particle board layer 67 can be bonded by means of the same binder composition as the substrate 3. It is also possible that the wood chips of the third particle board layer 67 are bonded by a thermoset resin, e.g. by means of a urea formaldehyde resin or a melamine formaldehyde resin.

The layered panels 30 of FIGS. 5 and 6 comprise couplings parts at least at to opposite edges. At a first edge, a male coupling part comprising a tongue 46 is provided. At the opposite edge a female coupling part comprising a groove 50 is provided. The groove 50 is bordered by an upper lip and 52 by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel to the surface of the coupled layered panels. In the example shown, the locking parts 56, 58 comprise a protrusion 56 at the lower lip 54, and a corresponding recess 58 at the bottom of the tongue 46.

FIG. 7 shows an example of a decorative sheet 1 according to the invention, wherein the decorative sheet is provided as a roll. This can e.g. be a decorative sheet as in FIG. 1.

FIG. 68 shows the front view of a piece of furniture 20 comprising a bent and a curved panel according to the invention. The piece of furniture 20 is a cabinet. It comprises a first panel 22 according to the invention, bent in U-shape. It comprises a second panel 24 according to the invention. The second panel 24 has been curved. The cabinet also comprises a shelf 26.

The first panel 22 and the second panel 24 can be panels as in FIG. 1. The panels can be brought into their final sheet by bending them using heat (which softens the elastomeric or thermoplastic halogen-free binder of the substrate of the panel) and pressure.

FIG. 9 diagrammatically shows an embodiment of the method according to the fourth aspect of the invention. Provided are a carrier layer 32, a substrate 3 and a décor layer 5. The substrate 3 is stacked onto the carrier layer 32 and the décor layer 5 is stacked onto the substrate 3, thereby forming a stack 80 comprising the substrate, the carrier layer and the décor layer.

The substrate 3 comprises wood chips and a thermoplastic halogen-free binder. In the example shown, the thermoplastic halogen-free binder is polyvinyl butyral (PVB). The substrate 3 consists of 45 wt % polyvinyl butyral (PVB) and 55 wt % wood chips. Optionally, the core layer can comprise a thermoset binder (e.g. a polyurethane binder) in addition to the thermoplastic halogen-free binder.

The substrate 3 comprises a layer of adhesive 69 on its surface directed to the carrier layer. The layer of adhesive 69 can have been applied to the substrate as an aqueous polyurethane dispersion. Alternatively, or in addition—a layer of adhesive can have been applied on the surface of the carrier layer directed towards the substrate; or a layer of adhesive (e.g. an adhesive film) can be positioned in the stack between the carrier layer and the substrate; and contacting the substrate and the carrier layer.

The décor layer 5 of the example is provided by a printed paper sheet impregnated with an acrylate resin. The acrylate resin is only partially cured to a non-tacky state and comprises a thermo-initiator. The side of the décor layer 5 directed towards the substrate 3 comprises a polyurethane adhesive 61 provided for laminating the décor layer 5 onto the substrate 3. The polyurethane adhesive can have been applied to the décor layer via an aqueous polyurethane dispersion.

A wear layer 7 has been provided onto the décor layer 5 via the application of an acrylic lacquer. The acrylic lacquer is only partially cured—to a non-tacky state—and comprises a thermo-initiator.

The carrier layer 32 is provided by a particle board. The particle board has a first particle board layer 63, a second particle board layer 65, and a third particle board layer 67. The second particle board layer 65 comprises on weight average basis finer wood chips than the first layer 63. The third particle board layer 67 comprises on weight average basis finer wood chips than the first particle board layer 63. The size distribution of the wood chips of the third particle board layer can be the same as the size distribution of the wood chips of the first particle board layer.

The wood chips of the first particle board layer 63 can be bonded by means of a thermoset resin, e.g. by means of a urea formaldehyde resin, a melamine formaldehyde resin, a methylene diphenyl diisocyanate (MDI) resin or a polyurethane resin.

The wood chips of the second particle board layer 65 can be bonded by means of the same binder composition as the first particle board layer 63.

The wood chips of the third particle board layer 67 can be bonded by means of the same binder composition as the first particle board layer 63.

The stack 80 is laminated by means of a press operation at elevated temperature. The adhesive layers 61, 69 are activated in this press operation.

In the example, the press operation at elevated temperature is performed by using a single daylight press comprising a structured press element 71 and a second press element 70.

As the acrylic lacquer of the wear layer 7 and the acrylate resin of the décor layer had been cured only partially, a texture can be provided during the press operation at elevated temperature by using a structured press element. The heat used in the press operation will further cure the acrylate resin and the acrylic lacquer. To this end, the heat of the press operation will active the thermo-initiators.

The present invention is in no way limited to the embodiments described as an example and represented in the figures, on the contrary it can be realized in various forms and dimensions, without leaving the scope of the invention.

1.-94. (canceled)

95. A decorative sheet or decorative panel, wherein the decorative sheet or decorative panel is less than 5 mm thick;
wherein the decorative sheet or decorative panel comprises or consists of a substrate, a decor layer and optionally one or more of a wear layer, a balancing layer and a resilient pad attach bottom layer;
wherein the substrate consists of a core layer; and optionally an upper layer and/or a lower layer;
wherein the core layer comprises core layer particles and a thermoplastic or elastomeric halogen-free binder;
wherein the core layer particles are selected from wood particles, preferably wood chips and/or wood fibers, cellulosic particles and cork particles, or a combination thereof.

96. The decorative sheet or decorative panel as in claim 95, wherein the thermoplastic or elastomeric halogen-free binder is selected from the list of polyvinyl butyral (PVB), styrene butadiene copolymer, ethylene vinyl acetate (EVA), polylactic acid (PLA), vinyl acetate-ethylene-vinyl ester copolymers, biobased polyester, thermoplastic polyurethanes, starch, polyolefines or mixtures thereof.

97. The decorative sheet or decorative panel as in claim 95, wherein the core layer comprises an additional binder,
wherein the additional binder is selected from the list of thermoset binder, polyurethane, hyperbranched polyamide, thermoset polyester or mixtures thereof.

98. The decorative sheet or decorative panel as in claim 95, wherein the weight percentage of the thermoplastic or elastomeric halogen-free binder in the core layer is at least 30%.

99. The decorative sheet or decorative panel as in claim 95, wherein the core layer comprises reinforcement fibers.

100. The decorative sheet or decorative panel as in claim 95, wherein the core layer comprises fillers,
wherein the fillers are selected from perlite, expanded glass particles, calcium carbonate, or talc; or a combination thereof.

101. The decorative sheet or decorative panel as in claim 95, wherein the substrate comprises an upper layer between the core layer and the decor layer;
wherein the upper layer comprises upper layer particles and an upper layer binder,
wherein the upper layer particles are selected from wood particles, cellulosic particles, and cork particles, or combinations thereof;
wherein the upper layer binder is a thermoplastic or elastomeric halogen-free binder; optionally wherein the upper layer comprises a thermoset upper layer binder.

102. The decorative sheet or decorative panel of claim 101, wherein the upper layer contacts the core layer.

103. The decorative sheet or decorative panel as in claim 101, wherein the decor layer is laminated or otherwise provided onto the upper layer.

104. The decorative sheet or decorative panel of claim 95, wherein the substrate comprises a lower layer at the other side of the core layer than the decor layer;
wherein the lower layer comprises lower layer particles and a lower layer binder,
wherein the lower layer particles are selected from wood particles, cellulosic particles and cork particles or combinations thereof;
wherein the lower layer binder is a thermoplastic or elastomeric halogen-free binder.

105. The decorative sheet or decorative panel as in claim 104, wherein the lower layer contacts the core layer.

106. The decorative sheet or decorative panel of claim 104, wherein the lower layer provides the bottom of the decorative sheet or decorative panel.

107. The decorative sheet or panel as in claim 101, wherein the core layer is thicker than the upper layer.

108. The decorative sheet or decorative panel as in claim 95, wherein the decor layer comprises a decor printed onto a carrier sheet.

109. The decorative sheet or decorative panel as in claim 95, wherein the décor layer comprises a resin impregnated printed paper sheet.

110. The decorative sheet or decorative panel as in claim 108, wherein the carrier sheet with its printed decor is laminated onto the substrate.
